(19) United States
(12) Patent Application Publication
(10) Pub. No.: US 2011/0280113 A1
(43) Pub. Date: Nov. 17, 2011

(54) Optical Storage System and Method for Writing Data to an Optical Disc

(75) Inventors: Jos Berckans, Taipei City (TW); Jurgen Vangeel, Taipei City (TW); Edwin Janssen, Taipei City (TW); Stefan Geusens, Taipei City (TW); Marc Cas, Taipei City (TW); Serge Wolfs, Taipei City (TW); Han Claas, Taipei City (TW); Frank Verhallen, Taipei City (TW); Peter Bollens, Taipei City (TW); Jan Bakx, Taipei City (TW)

(73) Assignee: LITE-ON IT CORPORATION, Taipei City (TW)

(21) Appl. No.: 12/780,041

(22) Filed: May 14, 2010

(51) Int. Cl. G11B 20/18

(52) U.S. Cl. 369/53.2; G9B/20.046

(57) ABSTRACT

The invention relates to an optical data system comprising an optical disc drive and a host. The optical disc drive is arranged to receive an optical disc and perform read and write actions with respect to the optical disc. The host is arranged to instruct the optical disc drive to perform a read or write action with respect to the optical disc. The optical disc drive may be arranged to
a) the optical disc drive is arranged to perform a quality measurement generating a plurality of quality parameters,
b) the optical disc drive is arranged to output the plurality of quality parameters to the host, and
c) the host is arranged to decide on a further action based on the received plurality of quality parameters.

### TECHNICAL FIELD

The invention relates to an optical data system comprising an optical disc drive and a host, a method for writing data to an optical disc, a computer program product and a computer readable medium.

### STATE OF THE ART

In an optical disc drive, data can be written on optical disc media (such as a CD, DVD, Blu-ray Disc (BD), HD DVD, DVD-RAM . . . ) from now on also referred to as optical disc or disc. To read or write data from/to the disc, a laser-based optical pick-up unit (OPU) may be used. This optical pick-up unit may be arranged to generate a laser beam and to scan the laser beam over the surface of the disc to read from or write data to the disc.

The optical disc drive may be controlled by a host, which may be a software tool running on a computer arrangement. The host and the optical disc drive together may form an optical data system.

The optical disc is composed of several layers, at least comprising two functional layers. A first layer is an information layer, which comprises the data or on which data can be written. A second layer is a protection layer. This protection layer is basically a substrate, which separates and therefore also protects the information layer from the outside world. The laser beam of the optical pick-up unit will pass through this protective substrate to read data from or write data to the information layer of the disc.

The optical disc may be placed in the optical disc drive and forms an interchangeable and cheap data storage medium. The disc drive may function under control of a host, for instance a software tool running on a personal computer, in which the disc drive is positioned.

Optical disc media are produced worldwide by numerous manufacturers. Because of this mass production, the quality of an optical disc may vary. Although the disc has to meet strict specifications, the optical disc drive manufacturer has no control on the quality of the optical discs. The quality of the optical disc will influence the quality of a writing process performed with respect to this optical disc.

The optical disc drive is manufactured to meet the quality standards. During the lifetime of the optical disc drive, the optical disc drive is exposed to several conditions which cause deterioration. The writing and reading quality can deteriorate during the lifetime of the optical disc drive.

Both the quality of the disc and the optical disc drive determine the maximum achievable reading and writing quality.

After finishing a writing action, the written data can be checked by verification on logical level. This verification is performed by the optical disc drive under control of the host. The result of the verification is a discrete value being either OK or NOT OK. Thus, a successful recording can only be determined after the writing action has been completed and verification has finished. A user will therefore not be able to get an indication whether the writing action is successful or not before the writing and verification has been completed.

The only earlier indication that is available to the host is an error during the start of the writing process of a failed Optimized Power Calibration (or Optimum Power Calibration—OPC) process, which is performed before data are actually written to the disc or a failure during the writing process itself. Such indications are always in the form of an OK or not OK message. There are no intermediate quality levels available. The OPC process is explained in more detail below.

The term OPC process as used in this text also refers to so-called running OPC process that may be performed during a writing process, after which further writing actions may be performed. Running OPC processes are explained in more detail below.

However, the quality of writing processes may vary, due to different disc qualities, different optical disc drives etc. Also, the required quality of writing processes may vary with the purpose for the user. For example, for data transfer (on rewritable discs), for private use (short data-lifetimes), the requirement of writing quality is less than in the case where data is to be stored for many years for e.g. archival of personal contents or governmental material.

Just as the quality of the writing process may vary, so does the writing time needed for performing a certain writing process. Because of this variable writing time, the writing time can vary a lot. Currently, writing time indications provided to the user are for example based on the current write performance and expected performance based on the write performance of the optical disc drive (e.g. CAV, CLV or ZCLV writing). Also techniques like Verify After Write techniques (VAW-techniques) and Fast Verify After Write techniques (FVAW techniques) that are developed as a variation to VAW-techniques. These FVAW techniques are described in U.S. patent applications Ser. Nos. 11/845,951 and 12/165,117 (which are incorporated by reference). The FVAW techniques influence the writing time that is needed by a writing process to be completed, thereby making the predicted writing time even more unreliable.

A more detailed explanation of VAW and FVAW-techniques is provided below.

It can be very frustrating for a user that the writing time predictions are very inaccurate or when the writing time indication changes much during writing.

Especially BD optical discs are sensitive to disc defects. To minimise the risk of disc defects several actions are taken (e.g. hard cover layer to limit disc scratches). It is nevertheless possible that defects will be present on the optical disc.

Many of such defects, like dust or fingerprints, can be removed easily. Other type of defects can not be removed, in which case a user may want to be informed about the presence of such defects.

Again, it is unpleasant for the user when e.g. a fingerprint at the outside of the optical disc causes problems during the writing process. A user may be confronted with a writing process that is going fast when suddenly problems are detected. The performance of the optical disc drive drops (for instance due to replacements of written data as a result of VAW-techniques) and possibly after a long time the writing process fails.

Some disc defects (e.g. caused by corrosion inside the disc) may not cause problems at a current stage, but may cause read back or record problems at a later stage, e.g. after (long time) storage. The presence of such defects may become relevant when reading from older stored optical discs, writing on new re-writable optical discs or when adding sessions to an optical disc.

Furthermore, the presence of disc defects may lead to a capacity of the optical disc that is less than expected. Also, when using VAW or FVAW techniques for writing, the writing time may vary as a result of the presence of defects, as it takes time to perform replacements.

According to the prior art, disc defects may result in a less than optimal performance and less than optimal data reliability. According to a prior art solution, the host may write multiple (redundant) copies of data on the optical disc to increase the data reliability.

The required laser power needed to write on an optical disc may be different for different optical discs and may be different for different disc drives. Usually the laser power is limited to a predetermined maximum value.

Although there are standards for each optical disk type and speed (e.g. 40× CD-R, 16× DVD+R) which define the maximum write power of the optical disk in [mW], it is in practice not guaranteed that an optical disc drive can write an optical disk at the target speed with sufficient power margin. Some media require powers that are close to the specified maximum value, or even exceed it. Recordable dye media are often very sensitive of the laser's wavelength, which may be different for different optical disc drives. An optical disc drive with a high-wavelength laser requires more power than an optical disc drive with a low-wavelength laser. Also a standard doesn't take surface contamination into account.

Furthermore, the required laser power may vary during a write action due to changing conditions.

So possibly, an optical disc drive may have insufficient power to perform a write action on an optical disk at the required speed. This may result in poor data quality, or even in loss of data.

### SHORT DESCRIPTION

It is an object to solve at least one of the above mentioned problems by having more information available at the host level.

According to an aspect there is provided an optical data system comprising an optical disc drive and a host,

the optical disc drive being arranged to receive an optical disc and perform read and write actions with respect to the optical disc,

the host being arranged to instruct the optical disc drive to perform a read or write action with respect to the optical disc, wherein

a) the optical disc drive is arranged to perform a quality measurement generating a plurality of quality parameters,

b) the optical disc drive is arranged to output the plurality of quality parameters to the host, and

c) the host is arranged to decide on a further action based on the received plurality of quality parameters.

According to a further aspect there is provided a method for writing data to an optical disc using an optical storage system, the optical storage system comprising an optical disc drive and a host,

the optical disc drive being arranged to receive an optical disc and perform read and write actions with respect to the optical disc,

the host being arranged to instruct the optical disc drive to perform a read or write action with respect to the optical disc, wherein the method comprises

a) performing a quality measurement generating a plurality of quality parameters by the optical disc drive,

b) outputting the plurality of quality parameters from the optical disc drive to the host, and

c) deciding by the host on a further action based on the received plurality of quality parameters.

The quality measurement may comprise a calibration process and/or a pre-scan. The pre-scan may comprise at least one of the tracking quality and the focus error signal and the plurality of quality parameters is at least partially based on the measured tracking quality and focus error signal. The pre-scan may comprise measuring data quality of previously written data on the optical disc and the plurality of quality parameters is at least partially based on the measured data quality.

The pre-scan may comprise measuring defects on the optical disc, wherein the plurality of quality parameters comprise a defect table based on the measured defects.

The optical disc may be divided in a plurality of zones and the pre-scan may be performed on a portion of zones.

The further action may be one of:

continue reading or writing process;

abort reading or writing process;

abort the writing process and suggest optical disc change to a user;

abort the reading process and suggest cleaning the disc;

provide warning to a user;

adjust or optimise the reading or writing speed of the writing process;

compute and output quality prediction of the writing process.

The further action may also comprise deciding where on the optical disc to write data based on the defect table.

The writing process may be performed using Verify After Write or Fast Verify After Write techniques, and the further action comprises:

computing an expected writing time of the writing process based on the plurality of quality parameters, and

outputting this expected writing time.

According to a further aspect there is provided a computer program product comprising data and instructions that can be loaded by a computer arrangement, allowing said computer arrangement to perform such a method.

According to a further aspect there is provided a computer readable medium, comprising such a computer program.

### SHORT DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a computer arrangement according to an embodiment,

FIG. 2 schematically depicts a flow diagram according to an embodiment,

FIGS. 3, 4a and 4b schematically depict the result of quality measurements as may be performed,

FIGS. 5a, 5b and 5c show embodiments of interaction between a host and an optical disc drive,

FIG. 6 shows an optical disc divided in zones,

FIGS. 7 and 8 show embodiments of interaction between a host and an optical disc drive.

### DETAILED DESCRIPTION

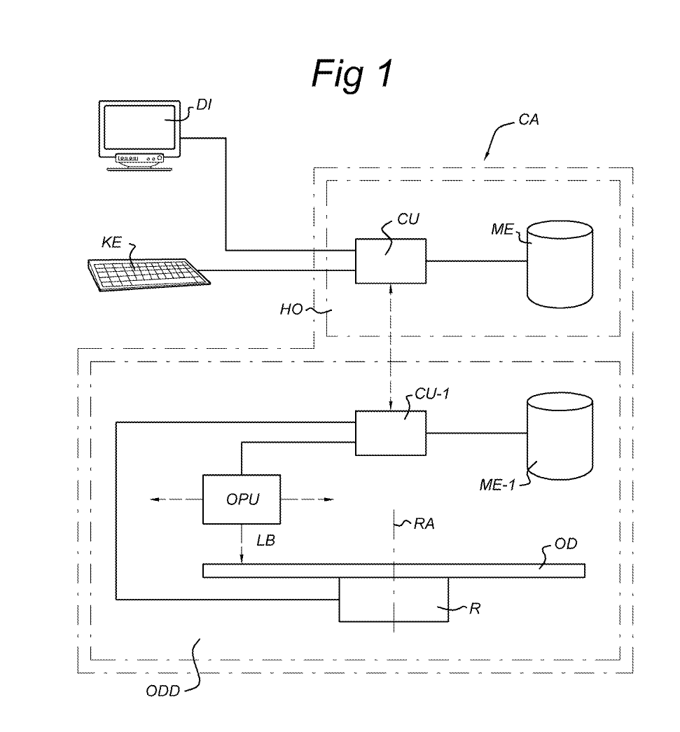

FIG. 1 schematically depicts a computer arrangement (CA). The computer arrangement may comprise a host control unit (CU). The host control unit may be or comprise processor as is known to a skilled person. When functioning as a host (HO), the host control unit of the computer arrangement may be arranged to control the optical disc drive (ODD). The host control unit may comprise or have access to a host memory (ME). The memory may comprise programming lines that are readable and executable by the host control unit to perform one or more of the embodiments presented here. The host memory may also comprise data that is to be written on the optical disc (OD). The host memory may be of any suitable type, such as ROM, RAM, EPROM etc.

As will be understood by a skilled person, the computer arrangement may further be arranged to be connected to peripheral equipment, such as a display (DI) and a keyboard (KE) to allow user interaction.

As already mentioned above, the computer arrangement may function as a host, for instance, by means of an appropriate software tool. The computer arrangement may further comprise an optical disc drive. The optical disc drive may be arranged to receive an optical disc and perform read and write actions on the optical disc. The host may be arranged to instruct the optical disc drive to read or write data to the optical disc. Together, the host and the optical disc drive may function as an optical data system.

The optical disc drive as shown in FIG. 1 comprises an optical disc, such as a CD, DVD, Blu-ray Disc (BD), HD DVD etc. The optical disc is usually substantially disc shaped, i.e. substantially round with a hole in the middle to allow the optical disc drive to receive and actuate (rotate) the optical disc.

The optical disc drive comprises an optical pick-up unit (OPU), arranged to generate a beam, such as a laser beam (LB), to be scanned over the surface of the optical disc to read data from or write data to the optical disc. The optical pick-up unit may be arranged to generate a write beam to write data and a read beam to read data from the optical disc, where the write and read beam may have different powers or intensities.

The optical pick-up unit is further arranged to move in a direction parallel to the surface of the optical disc, as indicated by the dashed arrows in horizontal direction according to FIG. 1. Also, the optical pick-up unit may be arranged to move in a direction perpendicular to the surface of the optical disc to position the information layer of the optical disc in the focal plane of the laser beam.

The optical disc drive further comprises at least one actuator, such as a rotation element (R) arranged to rotate the optical disc about a rotation axis (RA). Also further actuators may be provided to accurately position the optical disc and the laser beam with respect to each other. The term actuator is used to refer to all kinds of devices that are arranged to set things in motion, such as electric motors or hydraulic systems, robot arms etc.

The movements as performed by both the optical pick-up unit and the rotation element are controlled by a drive control unit (CU-1) of the optical disc drive such that the laser beam scans the surface of the optical disc in an appropriate way, for instance following a spiral path.

The drive control unit may be or comprise processor as is known to a skilled person.

The drive control unit of the optical disc drive may further be arranged to control the optical pick-up unit to read or write data to or from the optical disc. In case of a write operation, the drive control unit may provide the optical pick-up unit with the data that is to be written. In case of a read operation, the optical pick-up unit may be arranged to transmit the data that is read from the optical disc to the drive control unit for further processing.

The drive control unit may comprise or have access to a drive memory (ME-1) of the optical disc drive. The drive memory may comprise programming lines that are readable and executable by the drive control unit to perform one or more of the embodiments presented here. The drive memory may also comprise data that is to be written on the optical disc. The drive memory may be of any suitable type, such as ROM, RAM, EPROM etc.

The host control unit and the drive control unit are arranged to communicate with each other. Both the host control unit and the drive control unit may in fact be formed by more than one control unit or processor working in cooperation with each other.

### OPC

As mentioned above, before the actual writing of data is commenced, the optical disc drive performs an OPC (Optimum Power Calibration) process to calibrate the optical disc drive to obtain optimum writing quality. Such an OPC process is performed by the optical disc drive to calibrate the optimum power of the laser beam to perform a writing action. Such an OPC process is performed before the actual writing of data is started.

It is known that the laser power required to write a recordable or rewritable optical disk may vary, depending on the recording mechanism, the linear speed of the optical disk, the spot quality, the applied write strategy, the disk brand and the presence of surface contamination. This is the reason for performing the OPC procedure, which determines the optimum power under the applicable conditions.

The OPC process comprises several calibrations to optimise the write power to the optical disc, the optical disc drive and temperature. During the OPC, the best writing quality can be determined. The writing quality can be based on the results of the measurement done during the OPC. This level is not binary, as for instance limited to OK or NOT OK, but may contain several levels, and may thus adopt three or more different values.

In addition, a so-called running OPC process may be performed by the optical disc drive, to periodically update the write power of the laser to correct for changing conditions, such as the change in linear speed when recording in CAV mode. This may be done during a writing process, prior to performing further read or write actions.

The laser power may be controlled in a feedback loop that comprises a sensor which measures the power emitted by the laser. The writing power is always limited to a certain maximum value, which may not be exceeded in order to avoid damage of the laser. This value corresponds to a well-defined value of the sensor's output.

When the laser power is at its maximum (while it should be higher to obtain the required speed) the data integrity may be compromised. So it's important that there's always a sufficient power margin present to allow fluctuations of the required laser power.

Usually the host has no knowledge of the power requirements of the optical disk and of the available power in the optical disc drive. Also the user can not be informed of this. When the written data quality is poor, there's no way for the user to tell whether this is due to insufficient laser power or not.

Therefore it would be beneficial to have knowledge about the required and available laser power or the available power margin of the laser power available at the host. The host may use this information to decide how to proceed, possibly via user interaction. User interaction may involve informing the user of the required and available laser power or the available power margin of the laser power and asking the user for input based on this information.

### (F)VAW Explanation

VAW-techniques are known to the skilled person and involve verifying data portions that have been written. This verification may be done by reading back a data portion that has been written and e.g. compare this data portion to the source data, i.e. the data portion present in the memory that was sent to the optical disc drive to be written to the optical disc. If the verification shows that the written data portion can not be read back correctly or has a level of quality that is below a predetermined level of quality (using error statistics, jitter etc.), the host may decide to re-write the data portion, for instance on a specially dedicated area on the optical disc.

In general, the written data may be verified, where verifying may be any kind of quality measurement of the written data. To ensure data integrity, optical disc drives have a mode to write data to a disc and immediately verify the written data. If the written data is not reliable enough, the data is replaced to a replacement area.

Replacements are only possible in case the optical disc format comprises defect management (e.g. BD, DVD-RAM).

The FVAW-technique is explained in more detail in U.S. patent applications Ser. Nos. 11/845,951 and 12/165,117 that are incorporated by reference.

The FVAW-technique also involves verifying data portions that have just been written and possibly replace such data portions. However, in contrast to VAW-techniques, not all written data portions are verified. The FVAW-techniques involve a optical disc drive that decides if a written data portion is endangered, i.e. is likely to be of low quality, and only performs verification if a written data portion is endangered. It will be understood that FVAW-techniques influence the writing time that is needed by a writing process to be completed.

If the writing process is performed with a relatively high quality, written data portions are of relatively high quality, reducing the need for performing verifications and replacements, thereby reducing the required writing time.

### Position Control

For optical disc drives, the data is usually written in a spiral track. To keep the laser beam produced by the optical pick-up unit on track and to stay in focus, actuators may be provided to move the optical pick-up unit to position the optical disc in focus of the laser beam.

To control the movements of the actuators, position error signals may be derived from reflected laser light coming from the optical disc. The signal used to control the actuator displacements in radial direction is called the tracking error signal (TE). The signal used to control the actuator displacements in focus direction is called the focus error signal (FE). For stable tracking performance, the tracking error signal and focus error signal should remain within certain predetermined limits.

In order to minimize the tracking error signal and focus error signal, a feedback loop may be provided.

### Embodiments

According to embodiments, a disc quality measurement is performed by the disc drive and detailed information from this disc quality measurement is communicated to the host, allowing the host to decide on a next action in the writing process. By transferring quality information from the optical disc drive to the host, more sophisticated adjustments may be done to the planned writing process by the host, possibly allowing user interaction or providing more detailed information to a user about the writing process that is about to be performed.

According to an embodiment there is provided an optical data system comprising an optical disc drive and a host,

the optical disc drive being arranged to receive an optical disc and perform read and write actions with respect to the optical disc,

the host being arranged to instruct the optical disc drive to perform a read or write action with respect to the optical disc, wherein

a) the optical disc drive is arranged to perform a quality measurement generating a plurality of quality parameters,

b) the optical disc drive is arranged to output the plurality of quality parameters to the host, and

c) the host is arranged to decide on a further action based on the received plurality of quality parameters.

Also provided is a method for writing data to an optical disc, using an optical storage system, the optical storage system comprising an optical disc drive and a host,

the optical disc drive being arranged to receive an optical disc and perform read and write actions with respect to the optical disc,

the host being arranged to instruct the optical disc drive to perform a read or write action with respect to the optical disc, wherein the method comprises:

a) performing a quality measurement generating a plurality of quality parameters by the optical disc drive,

b) outputting the plurality of quality parameters from the optical disc drive to the host, and

c) deciding by the host on a further action based on the received plurality of quality parameters.

The actions a), b) and c) may be performed prior to performing a read or write action. The actions a), b) and c) may also be performed after completing a reading or writing process or during a reading or writing process, prior to a next read or write action.

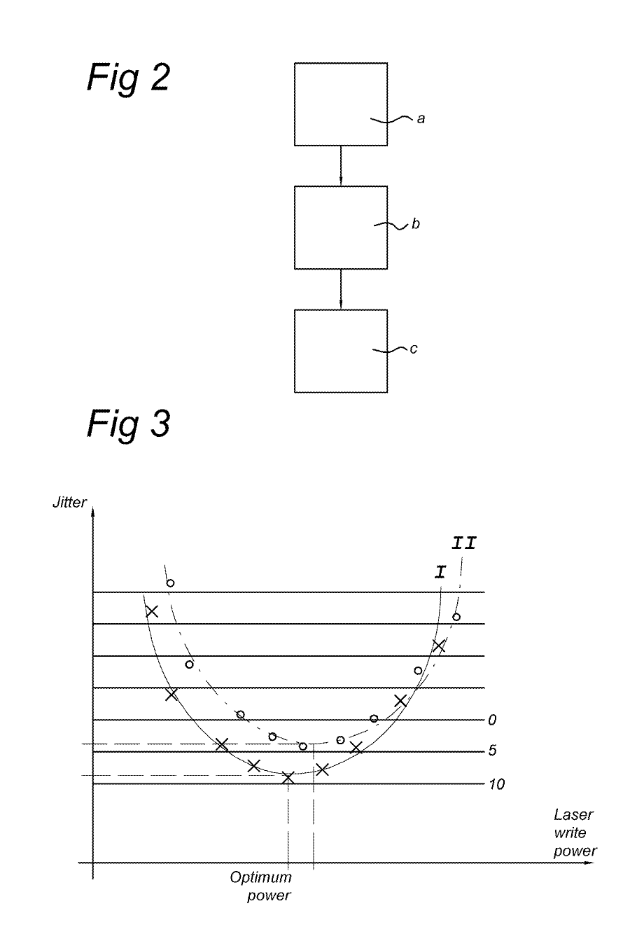

FIG. 2 schematically depicts a flow diagram, showing actions a), b), and c). These actions may be performed by the host and the optical disc drive together forming an optical data system.

The decision as taken in action c) may be done automatically by the host or may involve user interaction in which the host communicates the quality parameters or a user-friendly version thereof to the user (e.g. via display) and requesting the user to input a decision.

The plurality of quality parameters may be all sort of quality parameters comprising information about the quality of the optical disc and/or the quality of the combination of the optical disc and the optical disc drive. By making these quality parameters available to the host, the host can use these quality parameters to decide on a further action. This decision may involve user interaction.

The plurality of quality parameters may be non binary parameter, i.e. the quality parameters may be continuous parameters or may at least having three or more possible values. The plurality of quality parameters may comprise one or more of the following:

quality level (e.g. determined by OPC or calibrations)

defect table

tracking quality

photo-diode or error signal quality

data quality of (previously) written data

This will be explained in more detail below.

It will be understood that other suitable quality parameters may be used as well and the quality parameters listed here are just an example.

The photo diode or error signal quality is determined using the laser beam. The laser beam is reflected by the optical disc and passes the optics of the optical pick-up unit ending on the photo-diode. The photo-diode contains several segments of which combinations can be made. These photo-diode signals are passed to the control unit individually as diode signals or in a combined way, then called error signals, e.g. focus tracking error signal or radial tracking error signal or sum light.

These signals are input for the control loops which tend to minimize these errors to keep optimal tracking. Disturbances in the disc substrate or tracks etc. are noticed by disturbances in the photo-diode signals. The levels of these disturbances indicate a measure for the quality of the optical disc and may be comprised by the plurality of quality parameters.

### Embodiment 1

According to this embodiment, the quality measurement generating a plurality of quality parameters comprises a calibration process. Such a calibration process may be an OPC process and/or a running OPC process as explained above. The running OPC process is performed during a writing process, prior to further write or read actions.

The quality measurement may comprise a calibration procedure (e.g. OPC-procedure) generating a plurality of calibration parameters. These calibration parameters may be used as quality parameters or may be used to compute quality parameters.

According to an embodiment, the possibility is created to make the writing quality that is to be expected for a specific writing process available at the host. This information is made available to the host in an early stage of the writing process, i.e. after performance of the OPC. During the OPC, no data originating from the host (i.e. user data) has been written yet. Of course, the optical disc drive may write some test patterns (e.g. random or standard patterns) originating from optical disc drive itself as part of the OPC.

By communicating the plurality of quality parameters to the host, an indication can be provided to a user, informing the user about the quality level that is to be expected when using the particular optical disc (in combination with this optical disc drive). Depending on the purposes of the user, it can be decided to continue or abort the writing process before any user data is effectively written on the optical disc. In case the writing process is aborted before any user data is effectively written on the disc, another optical disc may be used for the writing process.

In case the writing process is aborted, the optical disc can still be used for other writing processes (in the same or an other optical disc drive), as the only information that is recorded on the optical disc in the OPC process are test patterns to check the writing quality which is written in the Inner or Outer Disc Test and Count Areas.

### Quality Parameters Determined in OPC

During the OPC calibration process, a number of quality parameters are determined. These quality parameters may relate to:

Jitter, such as data to data Jitter, Data to clock jitter, delta amplitudes on slicers, . . . ,

Beta (symmetry) or modulation,

Error rates (e.g. DVD: BLER/SER, PI/PO).

It will be understood that the list of quality parameters provided here is not limitative and other quality parameters may be used as well and variations to the quality parameters may be used.

It can be the cost that is used to identify the optimum power (during OPC). As such, in most cases, the cost is represented by Jitter (being data to data Jitter, Data to clock jitter, delta amplitudes on slicers, . . . ), or Beta (symmetry) or modulation.

The jitter (cost) is a function of the write power and at optimum write power, the jitter (cost) is lowest.

The OPC process comprises several calibrations to compensate for optical disc, disc drive and temperature effects. The optical disc drive uses the written test patterns in the test area to measure quality, expressed in quality parameters. These quality parameters are communicated to the host. The quality parameters may be mapped onto a certain scale. The quality parameters may be used by the host to predict the (overall) optical disc quality, once written. The quality parameters are an indication for the best achievable write quality as all necessary items are calibrated during this OPC.

A quality parameter may be any version of a signal or data that is measured by the optical disc drive. Of course, the measured quality parameter may be transformed into a quality indicator being a normalized version of a quality parameter that may for instance be obtained by mapping the quality parameter to a scale from 1-10. The term quality parameter as used here covers all manifestations of the measured quality parameters.

During the OPC procedure, data are written with different power/intensity of the laser beam. Next, a HF signal quality is measured and represented by a so called COST. From this data, an optimum is chosen/calculated for the power/intensity of the laser beam.

FIG. 3 shows two possible results of such a quality measurement as part of the OPC. The horizontal axis represents the power of the laser beam, while the vertical axis represents the jitter in %. The jitter can be expressed in % for DVD and BD optical discs. For other types of optical discs, such as CD's, the jitter may be expressed in nsec or %.

Curve I shows the results for an optical disc and an optical disc drive that perform very well. The cost (in this case jitter) at the optimum power is low and thus a relatively high quality parameter may be assigned.

Curve II shows the results for an optical disc and an optical disc drive that perform average (i.e. less well than curve I). The cost (Jitter) at optimum power is reasonable and thus a lower quality parameter may be assigned in comparison to Curve I.

As stated above, the quality parameter may be any version of a signal or data that is measured by the optical disc drive and may be mapped on a normalized version thereof, for instance, may be mapped on a quality indicator scale running from 1-10. Table 1 gives an example of how the quality parameter (in this case jitter) may be mapped onto a scale running from 1 to 10. This mapping may be done by the optical disc drive or the host.

TABLE 1

| Jitter at | Quality |
|---|---|
| optimum power | indicator |
| 6%-6.5% | 10 |
| 6.5%-7% | 9 |
| 7%-7.5% | 8 |
| 7.5%-8% | 7 |
| 8%-8.5% | 6 |
| 8.5%-9% | 5 |
| 9%-9.5% | 4 |
| 9.5%-10% | 3 |
| 10%-10.5% | 2 |
| 10.5%-11% | 1 |
| 11%-11.5% | 0 |

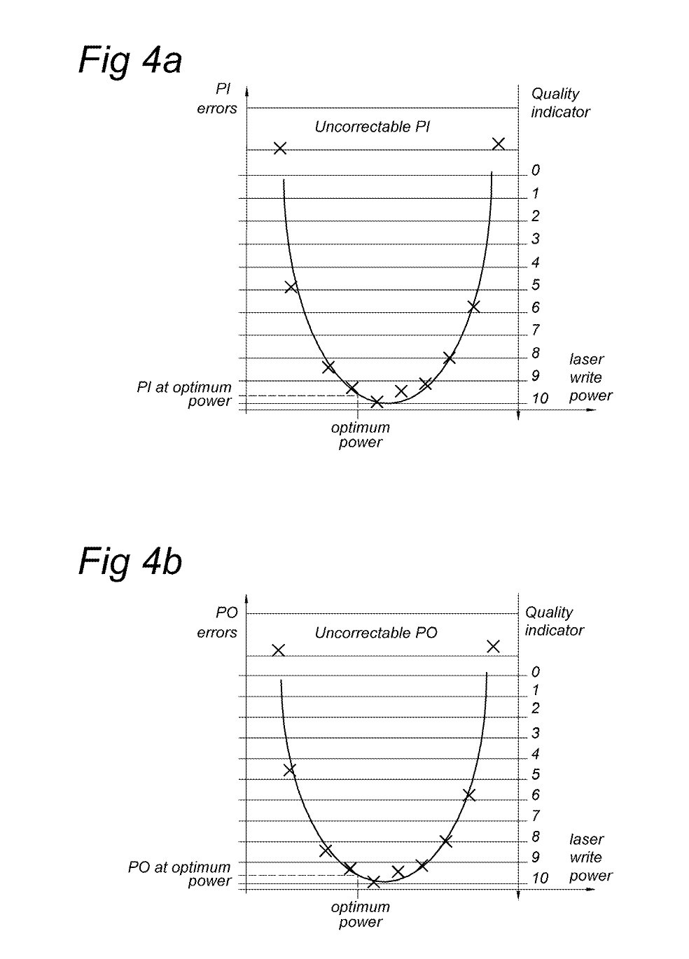

The quality parameters may also relate to other properties, such as Error statistics (DVD: PI/PO) as shown in FIGS. 4a and 4b.

FIGS. 4a and 4b are similar to FIG. 3, except that cost is replaced by PI and PO errors (amount of errors on DVD with Inner and outer error correction respectively). The overlaying zone uncorrectables defines an area in which the power is too low or too high to get any usable data (and thus, uncorrectable).

So, where in this text the term quality parameter is used, it is to be understood that this may also be a quality indicator and vice versa, as these are just difference manifestations of the same.

It will be understood that for performing action c) in which a decision is made on a further action based on the received plurality of quality parameters, the plurality of quality parameters may be combined in any arithmetical way, such as by summation, averaging, weighted averaging etc. Although the decision is made by the host, the arithmetical operations may at least partially be performed by the optical disc drive.

The plurality of quality parameters determined in the OPC process or running OPC process may comprise information about the maximum required and available laser power and/or the available power margin of the laser power. The power margin may be expressed in a percentage of the maximum available laser power.

The host may receive this information and report it to a user, for instance, via the display. The laser power may be shown in a graph, for instance, as a function of the radius of the optical disc. This may be done prior to starting a writing process, during the writing process (running OPC) or after the writing process is completed.

It is also possible to show a danger zone or area in the graph, e.g. where the laser power is close to its maximum, for instance >95%.

The host or the user (via user interaction by the host) may check if the required laser power is below a predetermined threshold, for instance 90%, of the maximum laser power. If not, the host may suggest or decide (in action c)) to switch to a lower writing speed or to use another optical disc.

So, according to an embodiment, the plurality of quality parameters may comprise information about at least one of:

the maximum required and available laser power

the available power margin of the laser power.

As described above, in action c), the host decides on a further action based on the received plurality of quality parameters. The further action may, for instance, comprise at least one of:

continue reading or writing process;

abort reading or writing process;

abort the writing process and suggest optical disc change to a user;

abort reading process and suggest cleaning the disc

provide warning to a user;

adjust or optimise the reading or writing speed of the writing process;

compute and output quality prediction of the writing process.

If the quality parameters meet predetermined threshold values, the host may decide to continue the writing process. If the quality parameters do not meet predetermined threshold values, the host may decide to abort the writing process.

By communicating the plurality of quality parameters to the host and thereby allowing decision action c), the possibility is created to continue (or abort) the writing process based on a quality indication. This allows taking into account quality requirements, which is not enabled by a simple OK or not-OK message from the optical disc drive to the host. Thereby it can be prevented to make recordings that turn out to be useless afterwards as the writing quality appears to be insufficient in comparison to the required quality.

According to an example, the embodiments may be performed prior to a read action, where the further action may comprise providing a warning to a user that defects are present on the optical disc, and possibly suggest the user to clean the optical disc. Also, before reading and playing a movie, the user may be warned that possible problems may occur. The user can than decide by providing input to continue or abort the reading and playing of the movie.

The decision may be to continue the writing process with an adjusted writing speed, thereby influencing the quality of the writing process. Reducing the writing speed may result in an increased quality and vice versa.

### General Scenario

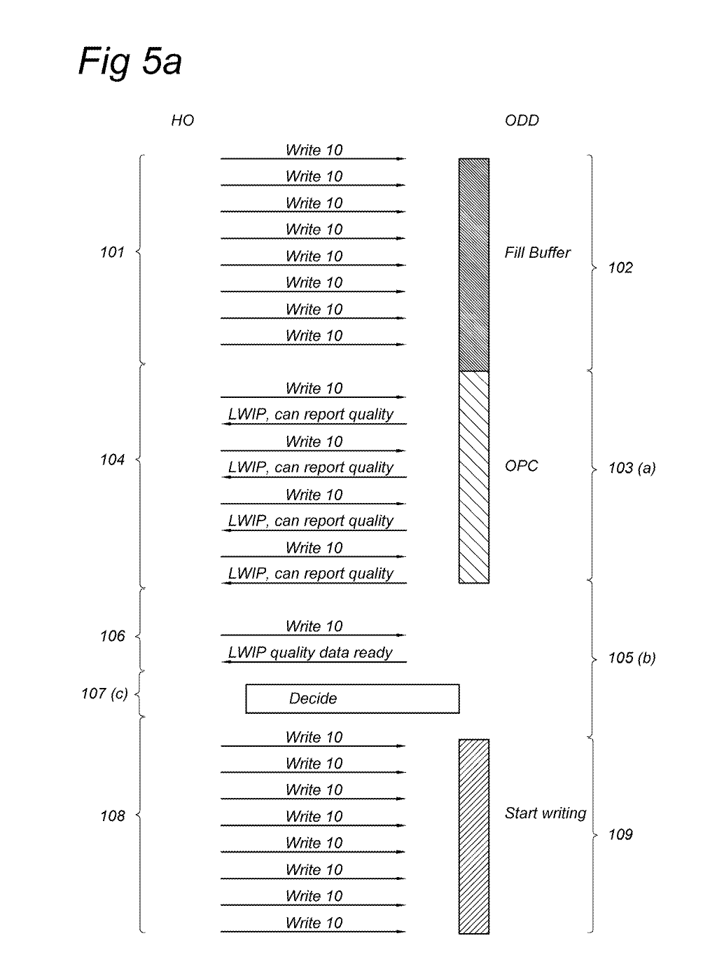

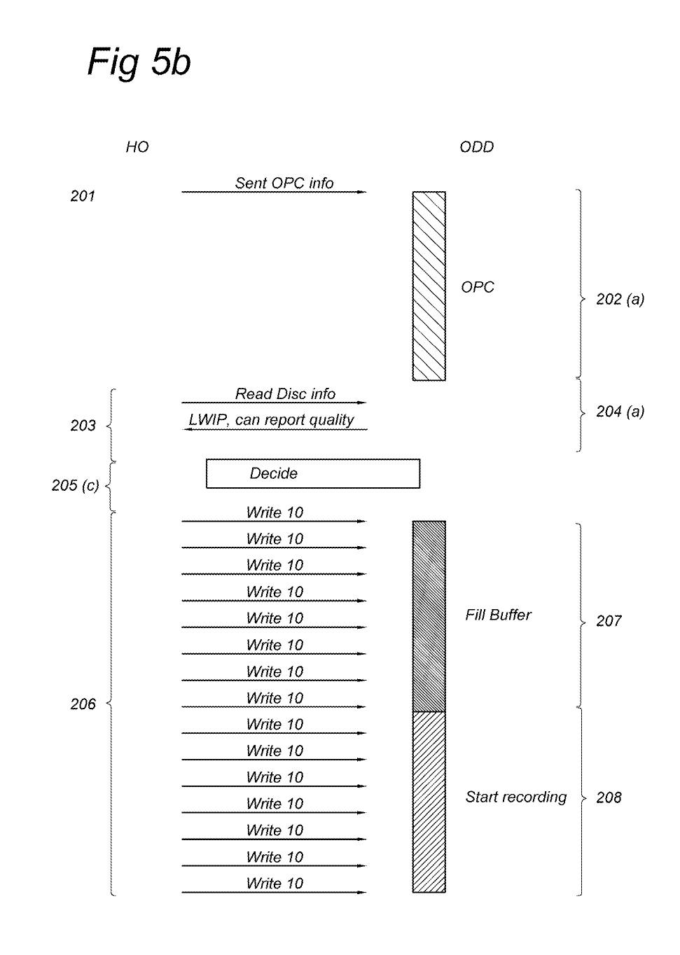

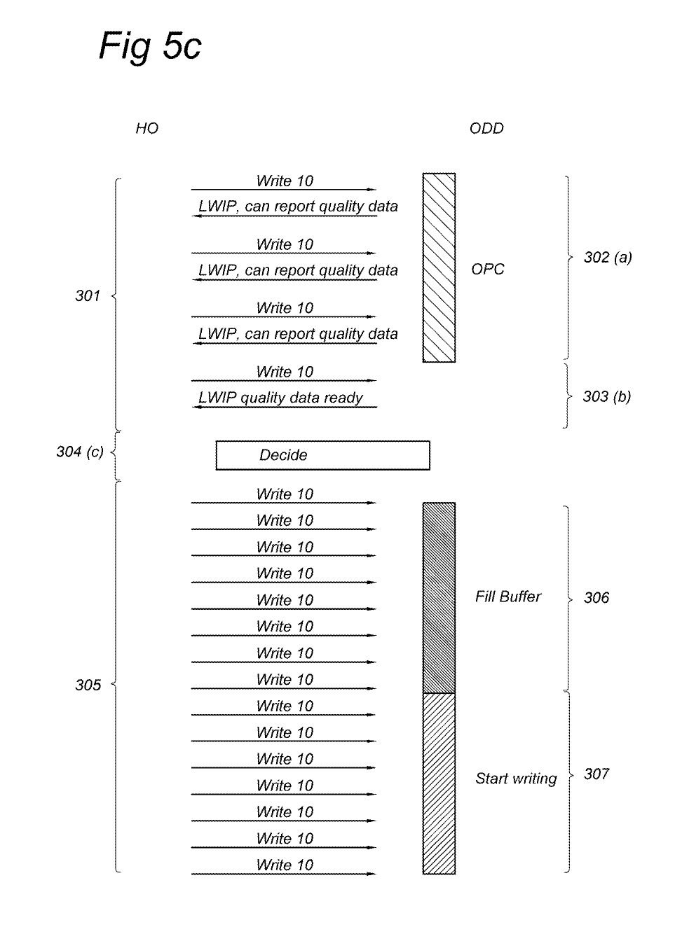

An example is described with reference to FIG. 5a. The host has data that are to be written on a writable medium, such as an optical disc. The host may have this data stored in the host memory.

In a first action 101, the host starts initiating write commands (write 10 in FIG. 5a) to the optical disc drive, the write commands comprising data portions of the data that is to be written. The optical disc drive stores the received data portions in a buffer, for instance in drive memory, in action 102.

Once the optical disc drive has received a certain amount of write commands, the optical disc drive decides to start the calibration process needed for optimal recording quality, such as an OPC process as discussed above. This is done in a further action 103, that corresponds to action a) in FIG. 2.

In this OPC process, the optical disc drive defines an indicator for optimal write and read quality on the current optical disc.

As described in the SCSI PRIMARY COMMAND specifications the optical disc (also referred to as logical unit according to SCSI terminology) addressed with a CDB (CDB=command description block, carrying the data of a command in which the previous specifications define its definition) responds with sense data, described in the same document.

Definitions and the like can be found in documents as the SCSI Command specifications, Mt Fuji Commands for Multi media devices and Multimedia command specifications (T10), which are incorporated by reference.

During action 103, the host may continue sending write commands (action 104) that are refused by the optical disc drive, as the buffer is already completely filled and the OPC process is on-going. The optical disc drive is busy calibrating the current optical disc and will issue a not-ready signal as part of action 103. According to SCSI PRIMARY COMMAND specifications, such a not-ready signal may be LWIP (Long Write In Progress):

However, according to an embodiment, in the sense data some data is added to communicate to the host that the optical disc drive supports the technique according to the embodiments. During the OPC, the optical disc drive may use this sense data to indicate that the host can report quality parameters. Also see table 2, which is in accordance with the SCSI command specifications and describes a logical field in the communication process between optical disc drive (Logical Unit) and the host (invoking the commands).

It will be understood that the above is just an example and other bytes may be used for communicating quality parameters as explained here.

Once the OPC process is finished, the optical disc drive sends a ready-signal, for instance a LWIP message to the host now comprising the plurality of quality parameters, for instance stored as sense bytes. This is done in action 105 that also corresponds to action b) in FIG. 2.

The plurality of quality parameters are received by the host in action 106. Based on this plurality of quality parameters, the host may decide how to continue in action 107, which corresponds to action c) in FIG. 2.

According to the example provided here, the host decides in action 107 to continue the writing process, depicted by action 108 in FIG. 5a.

Of course, after action 107 the host may also decide to perform another action, like for instance aborting the writing process. This is not shown in FIG. 5a, but may be done by the host by sending an appropriate abort command (e.g. a modified Sync Cache Command) to the optical disc drive.

FIG. 5b schematically shows an alternative method. According to this embodiment, the host initiates the write process in an action 201 by sending an OPC info request to the optical disc drive. In response thereto, the optical disc drive performs the OPC process in action 202 and sends a response to the host comprising the plurality of quality parameters in action 204. Action 202 corresponds to action a) in FIG. 2 and action 204 corresponds to action b) in FIG. 2.

As shown in FIG. 5b, action 204 may be performed in response to action 203. In action 203, the host sends a Read Disc Info message to the optical disc drive. This Read Disc Info message may for instance be an ATAPI command, send to retrieve some data read by the optical disc drive from the optical disc (possible writings speeds, disc manufacturing codes, proposed powers from the disc manufacturer to use when writing this disc, . . . ). The quality data can be part of return data on this command (action 204).

Once the host has received the plurality of quality parameters, the host is arranged to decide on a further action based on the received plurality of quality parameters in action 205, i.e. the host is arranged to decide whether to start the writing process or not. If the plurality of quality parameters indicates that the expected quality is too low, the host may cancel the writing process. If the plurality of quality parameters indicates that the expected quality is high enough, the host may continue the writing process and send writing commands to the optical disc drive. These writing commands may then be used to fill a buffer in the optical disc drive (action 207) and subsequently start the actual writing process in the optical disc drive in action 208.

Action 205 corresponds to action c) in FIG. 2.

FIG. 5c schematically shows an alternative method. According to this embodiment, the host starts with sending a writing command to the optical disc drive in action 301. The optical disc drive responds by initiating the OPC process and by sending a not-ready signal to the host. This is done in action 302 which corresponds to action a) in FIG. 2. According to SCSI-3 Multimedia Commands specifications, such a not-ready signal may be LWIP (Long Write In Progress) as described above.

Once the OPC process is finished, the optical disc drive sends a ready-signal, for instance a LWIP message to the host now comprising the plurality of quality parameters, for instance stored as sense bytes. This is done in action 303, which corresponds to action b) in FIG. 2.

Once the host has received the plurality of quality parameters, in action 304 the host is arranged to decide on a further action based on the received plurality of quality parameters, i.e. the host is arranged to decide whether to start the writing process or not, for instance based on expected quality. This corresponds to action c) in FIG. 2.

If the host continues the writing process, the host starts sending writing commands to the optical disc drive in action 305. These writing commands may then be used to fill a buffer in the optical disc drive (action 306) and subsequently start the writing process in the optical disc drive (action 307).

### Example 1

A host (in accordance with the embodiments) initiates a write command (e.g. write 10) to start the writing process. The optical disc drive starts the calibrations needed, and buffers the data. The host starts polling with test unit ready, or sends a next command (can be the next write command). The optical disc drive, being busy calibrating for the write process responds with sense key—additional sense code—additional sense code qualifier=020408: LONG WRITE IN PROGRESS. Some extra data in the sense data indicates that the optical disc drive is still busy gathering quality information. The host responds as normal to LONG write in progress, but knows (because of this extra data) that the optical disc drive can handle disc quality information, i.e. functions in accordance with the embodiments.

As soon as the optical disc drive collected a plurality of quality parameters (and possibly processed these quality parameters, e.g. into a quality indicator), the extra data in the sense data indicates that the quality information is available, and thus, the quality information is present in this extra data, which contains some storage space to store the plurality of quality parameters.

The host can now perform action c), i.e. it can decide to continue writing or take other actions. If the host decides to continue writing, the data sent by host will be written to the optical disc and the optical disc drive and host respond in the normal way.

### Example 2

A host that is not arranged in accordance with the embodiments, which initiated the first write command starts polling with test unit ready, or sends a next command. The optical disc drive responds with sense key—additional sense code—additional sense code qualifier=020408: LONG WRITE IN PROGRESS.

Some extra data in the sense data indicates that the optical disc drive is still busy gathering quality information. The host responds as normal to LONG write in progress. Just as in the example 1 above, the plurality of quality parameters is eventually reported to the host. However, since the host is not arranged to process the plurality of quality parameters, the host will ignores this data and the host will respond in the normal way (no sense).

### Embodiment 2

As described above, the writing time that is needed by a writing process to be completed may vary and may be difficult to predict. Writing processes may also fail halfway due to the presence of dust or fingerprints and the like on the optical disc. These disadvantages can be overcome by an embodiment in which a pre-scan of the optical disc is performed prior to the writing process. The pre-scan may be performed by the optical disc drive and may result in a plurality of quality parameters that can be transferred to the host. The host may be arranged to decide on a further action based on the received plurality of quality parameters. Such a further action may comprise computing a more reliable predicted writing time or advising the user to clean the optical disc before starting the writing process.

According to a further embodiment, the quality measurement generating a plurality of quality parameters as performed under a) (see FIG. 2) comprises a pre-scan. The pre-scan may be performed by the optical disc drive prior to the writing process and possibly prior to the OPC process as described above.

The optical disc drive may be arranged to perform the pre-scan upon insertion of an optical disc without direct instruction from the host.

The pre-scan may be performed without or with limited performance loss for the user (i.e. the user will not or hardly notice any performance loss). Usually several seconds are available between insertion of the optical disc in the optical disc drive, the moment the writing command is given from the host to the optical disc drive and the actual user data is being written onto the disc. This time is usually used by a user to communicate with appropriate software-tool controlling the writing process. These seconds may be used to perform the pre-scan, so that the user doesn't notice that a pre-scan of the optical disc is done.

In general, a pre-scan may be performed by performing a read action (whether or not any data are present) and monitor servo signals like the tracking error signal and the focus error signal, monitor presence of defects and monitor the data quality of data (if present). The data quality may be monitored by analyzing jitter, BLER etc.

The information obtained from the pre-scan may be used to improve the prediction of the writing time and/or to inform the user about the quality of the optical disc if needed. Examples of such warning are:

Warning fingerprints: advise to clean disc or replace disc

Warning black dots: advise to clean disc or replace disc

Warning very bad data quality on disc: advise to take new disc or make back-up of existing disc.

The pre-scan may be performed to gather quality parameters about:

1. Disc tracking quality (e.g. radial and focus tracking performance)

2. defect detection (e.g. checking reflected light)

2. Scanning data quality on disc.

The disc tracking quality may be controlled by determining the tracking error signal and the focus error signal. For stable tracking performance the tracking error signal and focus error signal must remain within certain predetermined limits as explained above. The disc tracking quality may further comprise detecting defects.

A skilled person will understand how to perform defect detection. The data quality can be determined by monitoring jitter, error statistics and the like.

So, based on the above, there is provided an embodiment wherein the pre-scan comprises measuring at least one of the tracking quality and the focus error signal and the plurality of quality parameters is at least partially based on the measured tracking quality and focus error signal.

Also provided is an embodiment wherein the pre-scan comprises measuring data quality of previously written data on the optical disc and the plurality of quality parameters is at least partially based on the measured data quality.

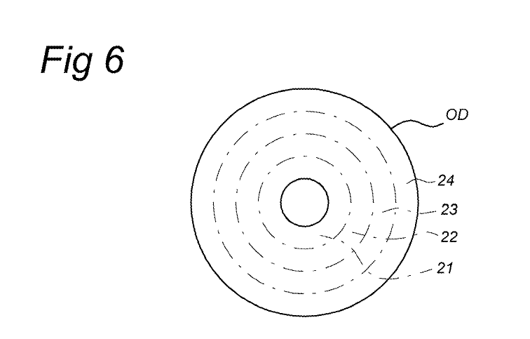

According to a further embodiment, the optical disc is divided in a plurality of zones 21, 22, 23, 24 and the pre-scan is performed on a portion of zones 21, 22, 23, 24. The zones 21, 22, 23, 24 may be ring shaped zones as schematically shown in FIG. 6.

By doing this, the time required for performing a pre-scan can be reduced, as instead of performing a pre-scan of the entire optical disc, only part of the optical disc is pre-scanned, thereby saving time and at the same time ensuring that the portions on which the pre-scan is performed are uniformly spread over the optical disc.

The pre-scan may be performed on each zone or only on a subset of the created zones. The portion of the zone on which the pre-scan is performed may be chosen differently for different zones, but according to an embodiment comprises at least 1 full rotation of the optical disc.

As described above, a technique referred to as Verify After Write and Fast Verify After Write is developed to have an optimal balance between performance (write time) and quality (no data corruption). As a result of this technique, the writing time becomes a function of the optical disc drive and the quality of the optical disc. This applies to both writable and re-writable optical discs.

According to an embodiment, the writing process is performed using Verify After Write or Fast Verify After Write techniques, and the further action comprises:

computing an expected writing time of the writing process based on the plurality of quality parameters, and

outputting this expected writing time.

For computation of the expected writing time, the host needs to know what kind of technique is used by the optical disc drive, i.e. write only, verify after write or verify after write with replacements. By estimating the number of necessary replacements and number of necessary verify actions (in case of FVAW), the host can compute an expected writing time. This estimation may be performed by using the plurality of quality parameters.

### Example

An example is provided of a writing process that uses a pre-scan. The optical disc may be divided up into 80 zones. For each zone the disc tracking quality (radial and focus tracking performance, defect detection) is measured and if data is present on the zone, the data quality is determined

The time needed to perform such a pre-scan can be computed as follows:

The tracking quality and data quality are measured at same time and this during 2 rotations. The rotational speed of the optical disc is 40 Hz, so per zone approximately 0.05 s is needed. The average seek time is approximately: 0.03 (relatively small seeks). So the total time needed to perform such a pre-scan is approximately: 80*[(2/40)+0.03]≅6.4 second.

After the pre-scan has been performed at least one or more of the following quality parameters can be known for each zone in which the pre-scan has been performed:

tracking error signal,

focus error signal,

defects,

(data quality and)

will optical disc drive perform verify actions or not in this zone.

These quality parameters can be outputted by the optical disc drive to the host and the host may be arranged to decide on a further action based on the received plurality of quality parameters.

It is noted that the host does not necessarily use full details of the quality parameters, but may only use some high level indications. Also the host may only use simple information about whether or not replacement actions and or verification actions are performed or expected in a certain zone. Accordingly, the host may simply extract these high level indications from the plurality of quality parameters or these high level indications are already extracted by the optical disc drive to be transmitted to the host.

The host can, for instance, decide for each zone if the received quality parameters are acceptable or not. If the quality parameters are not good enough for a predetermined amount of zones, as described above, the host may decide to

abort writing process;

abort the writing process and suggest optical disc change to a user;

adjust the writing speed of the writing process;

compute and output quality prediction of the writing process.

It will be understood that not all options are always open for the host depending on the quality parameters that are available.

In case the writing process is aborted, the optical disc can still be used for other writing processes, for instance in other optical disc drives, as the pre-scan is done in read mode so no actual data is written to the optical disc.

By creating the possibility to continue the writing process after having received the plurality of quality parameters, it can be prevented to perform writing processes that turn out to be useless afterwards as the quality of the writing process turns out to be insufficient or are insufficient with respect to expected/defined/chosen quality requirements.

Furthermore, the host may decide to

interrupt the writing process and suggest a user to clean the optical disc,

decrease the writing speed, or

ensure ‘endangered’ data is redundantly available on the disc.

This last aspect may be performed by the host using knowledge about endangered areas on the optical disc. The host may decide to duplicate data that is written in such an endangered area by writing a copy of the data on another location of the optical disc which is not endangered. So, by making detailed quality parameters available to the host, the duplication of data can be performed in a more sophisticated and efficient way, as according to the prior art, such detailed information was not available to the host and in some cases, duplication was performed for all data that was written to the disc (including data written to non-endangered areas).

The option of interrupting the writing process and suggesting a user to clean the optical disc involves detecting a fingerprint on the optical disc. Fingerprints may be detected from the plurality of quality parameters by analysing light reflected from the optical disc, and monitoring deflections of focus and tracking signals.

Defects may be detected by the disc drive and communicated to the host.

The host may for instance determine:

if tracking error signal is acceptable or not and consequently if and how many verification/replacement actions are likely to be needed as part of the VAW and FVAW technique,

if focus error signal is acceptable or not and consequently if and how many verification/replacement actions are likely to be needed as part of the VAW and FVAW technique,

how many defects are detected and consequently if and how many verification/replacement actions are likely to be needed as part of the VAW and FVAW technique, and

if data quality of previously written data is acceptable or not and consequently if and how many verification/replacement actions are likely to be needed as part of the VAW and FVAW technique.

The host may decide the above based on the plurality of quality parameters received. This quality parameters may comprise detailed information about the tracking error signal, focus error signal etc. However according to an embodiment, the tracking error signal and the focus error signal may be pre-processed by the optical disc drive to form high level indication thereof that can easily be evaluated by the host, i.e. by comparing them to a predetermined threshold value.

Based on this information, an accurate calculation of the expected writing time can be computed. If it is possible to classify the reason why the tracking quality is bad (e.g. fingerprints) than this information can be used by the host and the user can be advised to take action or not, e.g. by cleaning the optical disc.

It will be understood that the plurality of quality parameters that are being determined by the optical disc drive may already undergo some computations by the optical disc drive before being sent to the host. In fact, some preparatory computations to action c) may already been performed by the optical disc drive. However, it will be understood that making quality parameters (in any form) available to the host, allows the host to perform action c).

### Embodiment 3

As described above, the pre-scan may provide information about the presence of defects.

According to an embodiment, the pre-scan comprises measuring defects on the optical disc. According to a further embodiment, the plurality of quality parameters comprises a defect table based on the measured defects.

Therefore, according to a further embodiment, the pre-scan comprises measuring defects on the optical disc and the plurality of quality parameters comprises a defect table. The defect table may comprise information about the presence and location of defects on the optical disc. Thus, the plurality of quality parameters comprises a defect table in which the addresses of the defect locations on the optical disc are stored.

Different type of defect tables may be used.

One possible type of defect table is specified in the BD Spec. The defect table from BD spec is a list of addresses of defective locations.

Another possible type of defect table comprises a list of positions (less precise information of location on disc than address). For purpose of informing the host (or a user), both types of defect tables can be used. Of course, many other types of defect tables can be conceived.

For instance, the type of defect may also be comprised in the defect table generated based on the pre-scan, e.g. fingerprint which is a defect that can be cleaned by user.

Since information about the location of defects is shared with the host and thus the host is provided with detailed quality information, the host is allowed to provide a user with more detailed information before start of the writing process. Combined with the information available in the defect tables, the user can be informed that writing on this particular optical disc is not useful/recommended as there are not enough free areas available on the optical disc to complete a certain writing process (due to defects), or that not enough free areas are available on the optical disc when taking into account the expected number of replacements that are to be performed as part of the VAW or FVAW technique.

According to an embodiment, the further action (in accordance with action c)) comprises deciding where on the optical disc to write data based on the defect table. The host is arranged to decide where on the optical disc to write data and where on the optical disc not to write data based on the defect table. The information from the defect table can be used to inform the host application where the defect or suspicious areas on the optical disc are located. The host can then decide where to write and where not to write.

Also the host may decide what part of the data will be recorded twice on the optical disc. This way the host ensures that data on endangered locations on the optical disc can always be retrieved. The host could also decide not to write at all at the locations with relatively many defects. This would improve write performance as there would be no (or limited) verify and replacements actions required.

As indicated before, the host may decide to

decrease the writing speed, or

ensure ‘endangered’ data is redundantly available on the disc.

This last aspect may be performed by the host using knowledge about endangered areas on the optical disc. The host may decide to duplicate data that is written in such an endangered area by writing a copy of the data on another location of the optical disc which is not endangered. So, by making detailed quality parameters available to the host, the duplication of data can be performed in a more sophisticated and efficient way, as according to the prior art, such detailed information was not available to the host and in some cases, duplication was performed for all data that was written to the disc (including data written to non-endangered areas).

By decreasing the writing speed, it may be ensured that fewer errors are made during the writing process and as a result, less verifications and/or replacements are needed as part of the VAW or FVAW techniques. The Fast Verify After Write technique comprises several measurements to check whether the surrounding area on the optical disc can be written safely or whether the data to be written would be ‘endangered’ due to defects when it would be written at that location. The term endangered is used here to indicate that written data is likely to be of low quality or likely to comprise errors, making a replacement necessary. Each measurement results in a plurality of quality parameters that may be used to predict the overall disc quality, once written.

### Example

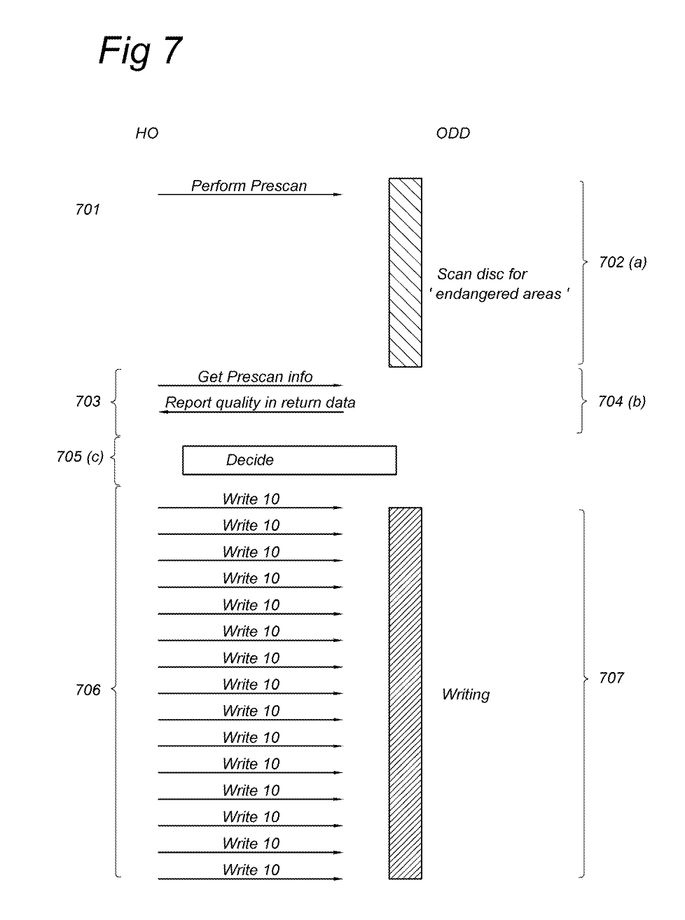

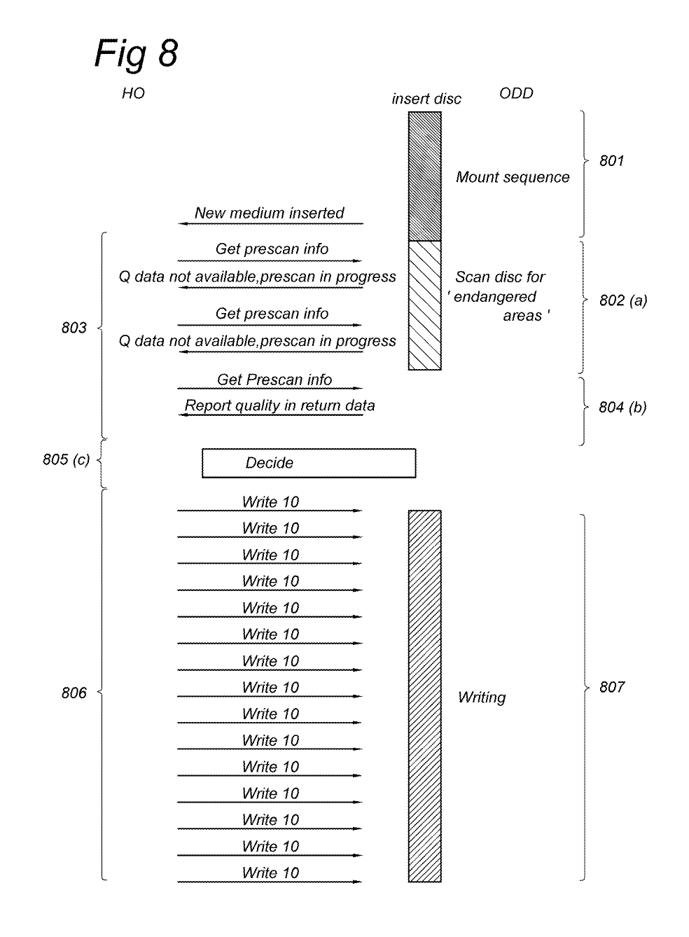

FIG. 7 schematically depicts an example of a host initiated pre-scan. According to this example, the host has data that is to be written on an optical disc. The host triggers the optical disc drive to perform a pre-scan in action 701 to determine defective areas on the optical disc. According to an alternative, the optical disc drive starts performing the pre-scan upon insertion of the optical disc in the optical disc drive. This is referred to as a drive initiated pre-scan, an example of which is described below with reference to FIG. 8.

The pre-scan may be performed on the entire area of the optical disc or may be performed on a part of the optical disc, for instance using zones 21, 22, 23, 24 as described above.

The optical disc drive performs the pre-scan in action 702, that corresponds to action a) in FIG. 2.

The host issues a command to retrieve the result information of the pre-scan in action 703. The pre-scan results in a plurality of quality parameters as described above, such as a defect table. Once the pre-scan is completed, the plurality of quality parameters is communicated to the host in action 704, corresponding to action b) in FIG. 2.

The plurality of quality parameters is sent to the host. Upon analysis of this plurality of quality parameters by the host, the host may determine that the quality of the optical disc is acceptable and may decide to continue or initiate a writing process. This is done in action 705, corresponding to action c) in FIG. 2.

If the host decides that the quality of the optical disc is not acceptable, the host may prompt the user to insert another optical disc or perform one or more of the other actions described above (advice user to clean the optical disc, etc.).

If the host continues the writing process (as in the example provided in FIG. 7), the host starts sending writing commands to the optical disc drive in action 706. These writing commands may then be used to start the writing process at the optical disc drive (action 707).

FIG. 8 schematically depicts an example of a drive initiated pre-scan. According to this example, a disc is inserted in the optical disc drive which triggers the optical disc drive to perform a mount sequence in action 801 and to perform a pre-scan in action 802 to determine defective areas on the optical disc. Action 802 corresponds to action a) in FIG. 2. During action 802, the optical disc drive communicates to the host that a new medium is inserted, to which the host replies with requests for pre-scan information (i.e. the plurality of quality parameters).

The pre-scan may be performed on the entire area of the optical disc or may be performed on a part of the optical disc, for instance using zones 21, 22, 23, 24 as described above.

Once the pre-scan is completed, the plurality of quality parameters is communicated to the host in action 804, corresponding to action b) in FIG. 2.

Actions 805, 806 and 807 are similar to actions 705, 706 and 707 explained above with reference to FIG. 7.

### Computer Program and Computer Readable Medium

According to a further embodiment there is provided a computer program product comprising data and instructions that can be loaded by a computer arrangement, allowing said computer arrangement to perform any one of the methods according to the embodiments.

The computer program product may be stored in the host memory and may be readable and executable by the host control unit. The computer program may be comprised by a computer readable medium.

### Further Remarks

The embodiments provided here are all explained with reference to optical discs, such as BD, HD-DVD, DVD, DVD-RAM, CD. However, it will be understood that the embodiments may also be applicable to other memory types, such as data storage drives etc. In general, the embodiments may all be applicable to any kind of arrangement for writing data to a memory type, such as recordable and rewritable media.

As can be understood based on the above explanation, the optical disc drive is arranged to send a plurality of quality parameters to the host. The host may or may not be arranged to receive and process these plurality of quality parameters. In case the host is arranged to receive and process the plurality of quality parameters, the host may perform action c). In case the host is not arranged to receive and process the plurality of quality parameters, the host may simply ignore the plurality of quality parameters and function according to the prior art.

Also, in case the host is arranged to receive and process the plurality of quality parameters but the optical disc drive is not arranged to make these quality parameters available to the host, the host may function according to the prior art, i.e. continue the writing process without performing action c).

So, it can be seen that the combination of a host and an optical disc drive of which only one is arranged in accordance with the embodiments described above functions well in accordance with the prior art.

Personal and professional users and applications can benefit of early expected quality level indication as explained in the embodiments.

The descriptions above are intended to be illustrative, not limiting. Thus, it will be apparent to one skilled in the art that modifications may be made to the invention as described without departing from the scope of the claims set out below.

1. An optical data system comprising an optical disc drive and a host,
the optical disc drive being arranged to receive an optical disc and perform read and write actions with respect to the optical disc,
the host being arranged to instruct the optical disc drive to perform a read or write action with respect to the optical disc, wherein
a) the optical disc drive is arranged to perform a quality measurement generating a plurality of quality parameters,
b) the optical disc drive is arranged to output the plurality of quality parameters to the host, and
c) the host is arranged to decide on a further action based on the received plurality of quality parameters.

2. The optical data system according to claim 1, wherein the quality measurement generating a plurality of quality parameters comprises a calibration process.

3. The optical data system according to claim 1, wherein the quality measurement generating a plurality of quality parameters comprises a pre-scan.

4. The optical data system according to claim 3, wherein the pre-scan comprises measuring at least one of the tracking quality and the focus error signal and the plurality of quality parameters is at least partially based on the measured tracking quality and focus error signal.

5. The optical data system according to claim 3, wherein the pre-scan comprises measuring data quality of previously written data on the optical disc and the plurality of quality parameters is at least partially based on the measured data quality.

6. The optical data system according to claim 3, wherein the pre-scan comprises measuring defects on the optical disc.

7. The optical data system according to claim 6, wherein the plurality of quality parameters comprises a defect table based on the measured defects.

8. The optical data system according to claim 3, wherein the optical disc is divided in a plurality of zones and the pre-scan is performed on a portion of zones.

9. The optical data system according to claim 1, wherein the further action is at least one of:
continue reading or writing process;
abort reading or writing process;
abort the writing process and suggest optical disc change to a user;
abort reading process and suggest cleaning the disc
provide warning to a user;
adjust or optimise the reading or writing speed of the writing process;
compute and output quality prediction of the writing process.

10. The optical data system according to claim 6, wherein the further action comprises deciding where on the optical disc to write data based on the defect table.

11. The optical data system according to claim 9, wherein the writing process is performed using Verify After Write or Fast Verify After Write techniques, and the further action comprises:
computing an expected writing time of the writing process based on the plurality of quality parameters, and
outputting this expected writing time.

12. The optical data system according to claim 2, wherein the plurality of quality parameters comprise information about at least one of:
the maximum required and available laser power,
the available power margin of the laser power.

13. Method for writing data to an optical disc, using an optical storage system, the optical storage system comprising an optical disc drive and a host,
the optical disc drive being arranged to receive an optical disc and perform read and write actions with respect to the optical disc,
the host being arranged to instruct the optical disc drive to perform a read or write action with respect to the optical disc, wherein the method comprises
a) performing a quality measurement generating a plurality of quality parameters by the optical disc drive,
b) outputting the plurality of quality parameters from the optical disc drive to the host, and
c) deciding by the host on a further action based on the received plurality of quality parameters.

14. A computer program product comprising data and instructions that can be loaded by a computer arrangement, allowing said computer arrangement to perform a method for writing data to an optical disc, using an optical storage system, the optical storage system comprising an optical disc drive and a host, the optical disc drive being arranged to receive an optical disc and perform read and write actions with respect to the optical disc, the host being arranged to instruct the optical disc drive to perform a read or write action with respect to the optical disc, wherein the method comprises
a) performing a quality measurement generating a plurality of quality parameters by the optical disc drive,
b) outputting the plurality of quality parameters from the optical disc drive to the host, and
c) deciding by the host on a further action based on the received plurality of quality parameters.

15. A computer readable medium, comprising a computer program comprising data and instructions that can be loaded by a computer arrangement, allowing said computer arrangement to perform a method for writing data to an optical disc, using an optical storage system, the optical storage system comprising an optical disc drive and a host, the optical disc drive being arranged to receive an optical disc and perform read and write actions with respect to the optical disc, the host being arranged to instruct the optical disc drive to perform a read or write action with respect to the optical disc, wherein the method comprises
a) performing a quality measurement generating a plurality of quality parameters by the optical disc drive,
b) outputting the plurality of quality parameters from the optical disc drive to the host, and
c) deciding by the host on a further action based on the received plurality of quality parameters.
